(19) United States
(12) Patent Application Publication
(10) Pub. No.: US 2007/0168740 A1
(43) Pub. Date: Jul. 19, 2007

(54) Method and apparatus for dumping a process memory space

(75) Inventors: Ola Nilsson, Akarp (SE); Staffan Mansson, Akarp (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/275,505

(22) Filed: Jan. 10, 2006

(51) Int. Cl. G06F 11/00

(52) U.S. Cl. 714/38

(57) ABSTRACT

A method and apparatus for facilitating postmortem debugging of a computer hardware failure. When an error occurs, a controller places a memory, such as a synchronous dynamic random access memory (SDRAM), in a self refresh mode in which the memory is able to retain its data contents. The data contents of the SDRAM are then written to a secondary storage location and a hardware reset is performed.

### TECHNICAL FlELD

The present invention relates to a method and apparatus for analyzing computer system failures.

### BACKGROUND

In many computer systems dumping a process memory space when a critical error occurs is standard procedure. On UNIX systems these are called core dumps, and the dumps contain the information needed for post-mortem debugging.

The same type of post-mortem debugging is conventionally done with other computer platforms, including, but not limited to embedded systems of user equipment (UE) or mobile stations (MS) such as mobile terminals used in communication systems. Conventionally, when an embedded system shuts down abnormally, dump data including information regarding the cause of crash, are written into the random access memory (RAM) area. Thus, the amount of dump data is equivalent to the entire RAM. This means that in order to write to flash, an area equaling the size of the RAM must be reserved on flash for the dump-file.

If the dump data cannot be moved from RAM to another space, for example, to a personal computer (PC), and the embedded system is re-booted, all of dump data is lost and the reason for the crash cannot be ascertained. There currently exists an obstacle to post-mortem debugging of UE and MS—that is the difficulty associated with the platform sending the memory data to a secondary location when it has failed. It is well known to those skilled in the art that modern synchronous dynamic random access memory (SDRAM) must be refreshed approximately every 16 microseconds to retain its memory contents. It is also well known that SDRAMs have a self refresh mode designed into the memory that reduces the power consumption during idle mode. During the hardware reset after a computer failure, there is a risk that the SDRAM will lose the contents needed for post-mortem debugging. In other words, resetting the computer hardware may result in the loss of data needed to perform post-mortem debugging. What is desired is the ability to perform core dumps to a secondary storage, for example, to a file system. However, to perform core dumps to a secondary storage, the computer system must be in a known state.

### SUMMARY

The present invention comprises a method of and apparatus for facilitating a post-mortem debugging of a computer failure by placing the computer into a known hardware state before dumping and saving the memory contents to a secondary storage location.

More specifically, an embodiment of the present invention comprises placing a memory, such as an SDRAM; in self refresh mode wherein the memory is able to retain its data contents, reading its data contents and writing the data contents to a secondary storage location, such as a file system, then performing a hardware reset.

### BRIEF DESCRIPTION OF THE DRAWINGS

FIG. 1 is a flow chart of an exemplary embodiment of the method of the present invention;

FIG. 2 is a flow chart of a “watchdog” embodiment of the method of the present invention; and

FIG. 3 illustrates an exemplary embodiment of the apparatus of the present invention.

### DETAILED DESCRIPTION

The present invention comprises a method of and apparatus for facilitating post-mortem debugging of a computer failure by resetting the computer into a known hardware state before saving the memory contents to a secondary storage location such as a file system.

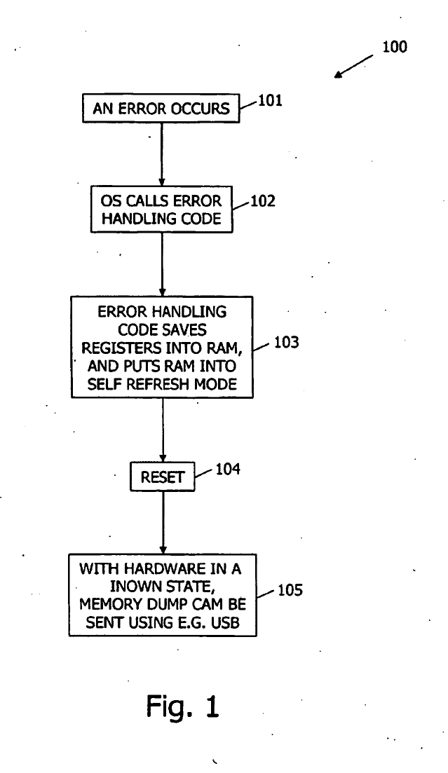

Synchronous dynamic random access memory (SDRAM) has a self refresh mode designed to reduce the power consumption during idle mode. FIG. 1 sets forth the steps 100 of controlled error handling using the method of the present invention. As seen therein, upon an error event 101, such as data abort the operating system calls error handling code at step 102. The error handling code saves the contents of a computer's registers into random access memory (RAM), such as SDRAM, and places RAM into self refresh mode at step 103. Then the hardware reset occurs at step 104. With hardware in the known state, the memory dump can be sent to a file system over a bus or other connection at step 105.

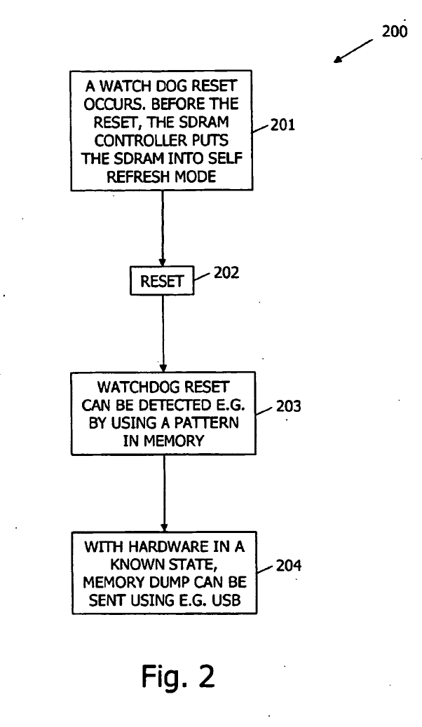

As seen in FIG. 2, the method 200 of the present invention can be further adapted as a “watchdog” to make sure that the computer system can be automatically restarted if a software failure occurs (for example if part of the software disables an interrupt, and goes into an eternal loop). When the watchdog determines to reset-the system, the reset is performed autonomously by hardware. No software can be involved as it is the software that has failed. Using the method and apparatus of the present invention, the watchdog hardware may first place the SDRAM in self refresh mode, and then reset the system. As seen in FIG. 2, before a watchdog reset occurs, the SDRAM controller puts the SDRAM in self refresh mode at step 201. Then hardware reset occurs at step 202. The watchdog reset can be detected at step 203 in a plurality of ways, including using a pattern in memory. With the computer hardware in a known state, the memory dump may be sent to a file system over a bus or other connection at step 204.

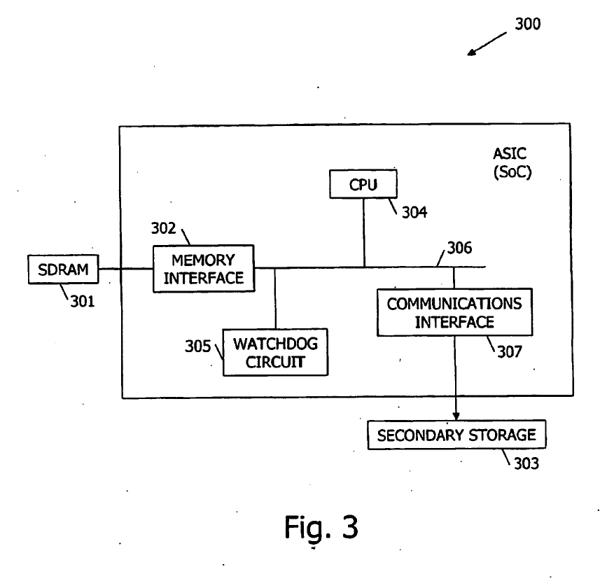

As seen in FIG. 3, the apparatus 300 of the present invention includes at least one memory cell such as an SDRAM 301, a corresponding memory interface 302 and a communication interface 307 to a secondary storage location 303. A microprocessor such as central processing unit (CPU) 304 includes at least one register and is adapted to read, transfer and operate upon contents between the at least one register and the at least one memory cell 301. A watchdog circuit 305 is adapted to place the at least one memory cell in self refresh mode in accordance with the method of the present invention. At least one bus 306 interconnects the at least one memory cell 301, the memory interface 302, the communication interface 307, the CPU 304, and the watchdog circuit 305. The foregoing apparatus, in combination with a display or other output device (not shown), permits an off line analysis to display information about the entire system, not just the processes executing when the failure occurred. The foregoing apparatus may be used in combination with debugging software so as to perform post-mortem analysis of a platform failure, such as a failure due to an overwrite of the computer's memory or I/O registers.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of facilitating post-mortem debugging of a computer, comprising:
detecting an error event by the computer;
saving, by the computer, register contents into a memory;
placing, by the computer, the memory into self refresh mode; and
reading, by the computer, the data contents of the memory to a secondary storage location.

2. The method of claim 1, further comprising performing, by the computer, a hardware reset.

3. The method of claim 1, further comprising executing a debugging software program on the data contents at the secondary storage location.

4. The method of claim 1, further comprising displaying information about the entire computer and the processes being executed when the failure occurs.

5. A method of facilitating the analysis of a computer failure, comprising:
placing the computer into a known hardware state;
saving the memory contents to a secondary storage location; and
dumping memory contents during a memory self refresh.

6. A method for automatically restarting a computer system in the event of a software failure, comprising:
placing, by a watchdog hardware circuit, memory in self refresh, and
resetting the system.

7. A method of controlled error handling in a computer, comprising:
detecting, by the computer, an error event;
calling, by the operating system of the computer, error handling code;
saving, by the error handling code, contents of registers into random access memory (RAM);
placing, by the operating system, the RAM into self refresh mode; and
resetting the computer hardware.

8. The method of claim 7, wherein the error event is a data abort.

9. The method of claim 7, further comprising dumping the RAM contents to a file system over a bus.

10. A method for automatically restarting computer hardware in the event of a software failure, comprising:
detecting, by a watchdog reset circuit, a software failure;
placing, by a synchronous dynamic random access memory (SDRAM) controller, SDRAM in self refresh mode; and
resetting the computer hardware.

11. The method of claim 10, wherein the software failure is detected by the watchdog reset circuit using a pattern in memory.

12. The method of claim 11, further comprising dumping SDRAM contents to a file system over a bus or other connection.

13. An apparatus adapted to facilitate post-mortem debugging of a computer platform, comprising:
at least one memory cell;
a memory interface coupled to the at least one memory cell
a watchdog circuit adapted to place the at least one memory cell in self refresh mode;
a central processing unit (CPU) having at least one register and being adapted to read, transfer and operate upon contents between the at least one register and the at least one memory cell via the memory interface; and
at least one bus coupling the at least one memory cell, the memory interface, the CPU and the watchdog circuit.

14. The apparatus of claim 13, further comprising an interface to a secondary storage location coupled to the at least one bus;
a secondary storage location coupled to the interface to a secondary storage location; and
the CPU adapted to read contents from the at least one memory cell via the memory interface to the secondary storage location via the interface to a secondary storage location.

15. The apparatus of claim 14, wherein the secondary storage system is a file system.

16. The apparatus of claim 13, in combination with debugging software adapted to be executed by the CPU and perform post-mortem analysis of a computer platform failure.

17. The apparatus of claim 16, wherein the computer platform failure is due to an overwrite of a memory or input/output (I/O) register.

18. The apparatus of claim 13, wherein the at least one memory cell is of a type that must be periodically refreshed.

19. The apparatus of claim 18 wherein the at least one memory cell is synchronous dynamic random access memory (SDRAM).

20. The apparatus of claim 13, wherein the watchdog circuit is adapted to perform a hardware reset.

21. The apparatus of claim 13, further comprising an output device adapted to display information about an entire computer and the processes executing when the failure occurs.

22. The apparatus of claim 21, wherein the display is a monitor.

23. An apparatus for automatically restarting a computer system in the event of a software failure, comprising:
at least one memory cell:
a watchdog hardware circuit adapted to detect a software failure;
a microprocessor having at least one register, the microprocessor being adapted to:
place the at least one memory cell in self refresh mode in the event of the detection of a software failure; and
reset the computer system; and
at least one bus coupling the at least one memory cell, the watchdog hardware circuit and the microprocessor.

24. The apparatus of claim 23 wherein the memory is of a type that must be periodically refreshed.

25. The apparatus of claim 24 wherein the memory is synchronous dynamic random access memory (SDRAM).
